(19) United States
(12) Patent Application Publication
(10) Pub. No.: US 2012/0153874 A1
(43) Pub. Date: Jun. 21, 2012

(54) ASSEMBLY AND METHOD FOR SUPPLYING ENERGY TO MOTORISED VEHICLES

(75) Inventors: Walter Lachenmeier, Sankt Augustin (DE); Tim Schaefer, Niedersachswerfen (DE); Andreas Gutsch, Luedinghausen (DE)

(73) Assignee: LI-TEC BATTERY GMBH, Kamenz (DE)

(21) Appl. No.: 13/148,954

(22) PCT Filed: Feb. 4, 2010
(86) PCT No.: PCT/EP10/00705

§ 371 Date: Mar. 13, 2012

(30) Foreign Application Priority Data
Feb. 11, 2009 (DE) 10 2009 008 513.0

(51) Int. Cl. B60L 11/12; H02K 7/02; B60L 11/02; F01K 27/00; F01K 13/00

(52) U.S. Cl. 318/1; 60/643; 60/645; 318/140; 318/139; 180/65.21

(57) ABSTRACT

To supply energy to motorised vehicles, a heat engine (SM) is provided to convert heat (106, 107, 108, 114) that accumulates in the vehicle at least partly into kinetic energy of the vehicle and to feed other portions of said lost heat to a heat accumulator (LWS). An optional, mechanical energy accumulator (MES) can take up kinetic energy from a vehicle motor (MGH), store said energy and deliver said energy back to a vehicle motor (MGM when required.

“Priority application DE 10 2009 008 513.0 is fully incorporated by reference into the present application”

The invention relates to an assembly and a method for supplying energy to motorised vehicles.

The protection of world energy reserves and an economical handling of energy is an important aim today in all fields of daily life and its technical support for ecological and economic reasons. Owing to the high proliferation of motorised vehicles, their great importance for our mobility and the considerable energy conversions connected therewith, the protective and economical use of energy is of particular importance namely in motorised vehicles.

This is found in particular also in electric vehicles. The still low specific charging capacity of batteries which are available today for the storage of electrical energy limits, for example, the range of coverage of electric vehicles and is a reason for the small dissemination of these vehicles. Air-conditioning and heating of an electrically operated vehicle are only possible to a limited extent, because thereby a further essential restriction to the range of coverage would be connected therewith. The market for electric vehicles which do not offer the accustomed comfort for the occupants is still insignificant today. In view of the fact that the prices for fuels will rise further in the next few years, it can nevertheless be assumed that electric vehicles will also reach an appreciable market share in the next ten years, if practicable solutions for the heating and air-conditioning, and hence an acceptable comfort for the occupants, are offered.

The present invention is based on the problem of indicating an assembly and a method for supplying energy to motorised vehicles, which supports this objective with progressive technical concepts. This problem is solved by an assembly and by a method according to one of the independent claims.

The invention provides an assembly and a method for supplying energy to motorised vehicles, in which a heat engine converts the heat that accumulates in the vehicle at least partly into kinetic energy of the vehicle and feeds other portions of this heat to a heat accumulator.

Terms used in connection with the description of the present invention are defined and explained below.

In the sense of the present invention, a motorised vehicle is to be understood to mean vehicles of all kinds which obtain their kinetic energy at least partially from a motor, which removes energy from a (so-called) energy source, (which according to the law of energy conservation physically correctly should actually be designated as an energy store), and converts this at least partially into kinetic energy of the vehicle. Typical examples of such motorised vehicles are, inter alia, motor vehicles for road travel, locomotives, ships and aeroplanes. Coming into consideration as motors in particular, but not exclusively, are internal combustion engines, electric motors and combinations of such drive units, so-called hybrid drives.

In the sense of the present invention, a heat engine is to be understood to mean an arrangement for the at least partial conversion of heat, i.e. microscopic kinetic energy, into macroscopic kinetic energy or into potential energy, which can also convert energy in the opposite direction, which therefore uses potential energy or macroscopic kinetic energy to make heat accumulating at a low temperature level available at a higher temperature level. On the basis of the generally known laws of thermodynamics, this can only be partially successful in the first direction; in the other direction, macroscopic energy, for example the potential electrical energy stored in a capacitor, or portions of the kinetic energy of a vehicle, is to be used in order to pump heat to a higher temperature level.

The present invention makes use of the existence of such heat engines and is not restricted to a particular type of such heat engines. An important example of such a heat engine is formed by the class of heat engines which are generally designated as Stirling engines. These machines have the advantage that they are largely independent of the choice of a specific process for the heat generation and can therefore be realized with heat accumulators and heat sources of the most varied kinds. The invention is, however, not restricted to Stirling engines or other known heat engines; it can basically also be realized with heat engines which are yet to be developed.

Heat accumulating in the vehicle is to be understood in the sense of the present invention to mean any kind of heat which accumulates in or on the vehicle. This can be, in particular, lost heat, i.e. the waste heat of any kind from energy consumers or energy converters in the vehicle, but also heat which occurs by a thermalisation of incident radiation, i.e. in particular by the heating of the vehicle interior, of the vehicle surfaces or collectors arranged on the surfaces.

In the sense of the present invention, a heat accumulator is to be understood to mean any arrangement which can receive, store and if required re-emit thermal energy. In particular, these can be so-called latent heat accumulators, which are based on the principle of the latent heat of a phase transition, generally a phase transition of the first order. The utilization of the enthalpy of reversible chemical reactions follows a similar principle: thus, e.g. of absorption- and desorption processes based on chemisorption. This takes place in so-called thermochemical heat accumulators, which make an even higher energy density possible.

In the sense of the present invention, the kinetic energy of the vehicle is to be understood to mean any form of macroscopic kinetic energy, which could be extracted from the vehicle. This includes in particular the kinetic energy of the vehicle in the closest sense, i.e. all forms of kinetic energy which are to be attributed to the motion of the vehicle in space, but in the broader sense also those forms of kinetic energy which are connected with the motion of vehicle parts (engine, wheels, etc.). Macroscopic energy is to be understood here to mean any form of energy which is not connected with the stimulation of microscopic (in particular molecular) degrees of freedom, and which therefore in principle—i.e. without infringing basic thermodynamic laws—can be converted entirely into different macroscopic energy forms.

A mechanical energy accumulator is to be understood in the sense of the present invention to mean any form of an energy accumulator in which energy can be stored reversibly in a mechanical manner, i.e. by stimulation of macroscopic degrees of freedom, such as in particular the rotation, the vibration or the reversible, for example elastic, deformation of macroscopic bodies. Important examples of such accumulators are flywheels or torsional spring accumulators. All mechanical energy accumulators can store macroscopic kinetic energy reversibly in the form of macroscopic kinetic or potential energy without conversion into other, for example chemical or electrical energy forms.

In the sense of the present invention, an electrochemical energy accumulator is to be understood to mean all forms of so-called galvanic cells. These are frequently designated colloquially as batteries or accumulators; they store electrical energy in chemical form and emit it again, as required, in the form of electrical energy. Important examples are lithium-ion batteries. These and some other electrochemical energy accumulators are distinguished by a high degree of reversibility.

Advantageous further developments of the invention form the subject matter of subclaims.

The invention is described in further detail below by means of preferred example embodiments and with the aid of figures, in which are shown:

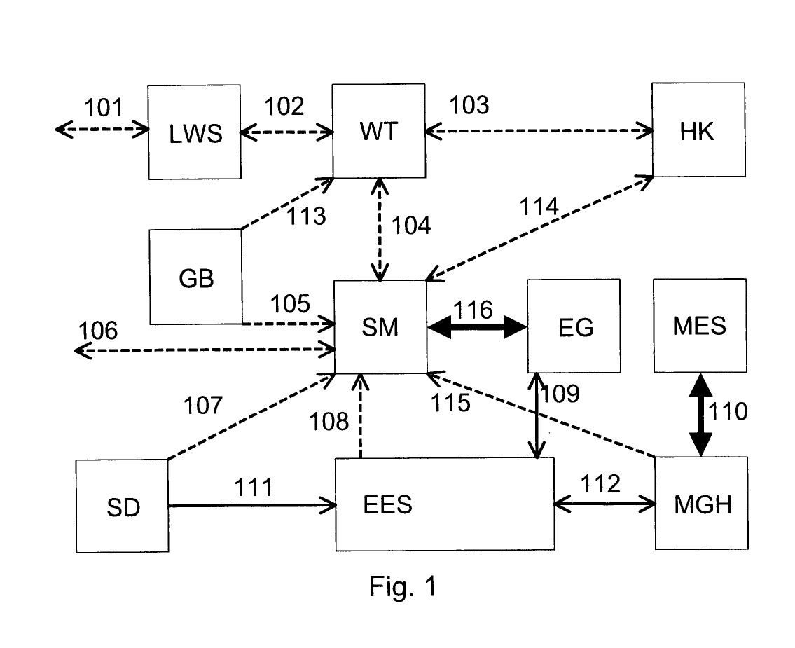

FIG. 1 a diagrammatic illustration of the assembly according to the invention by means of a preferred first example embodiment;

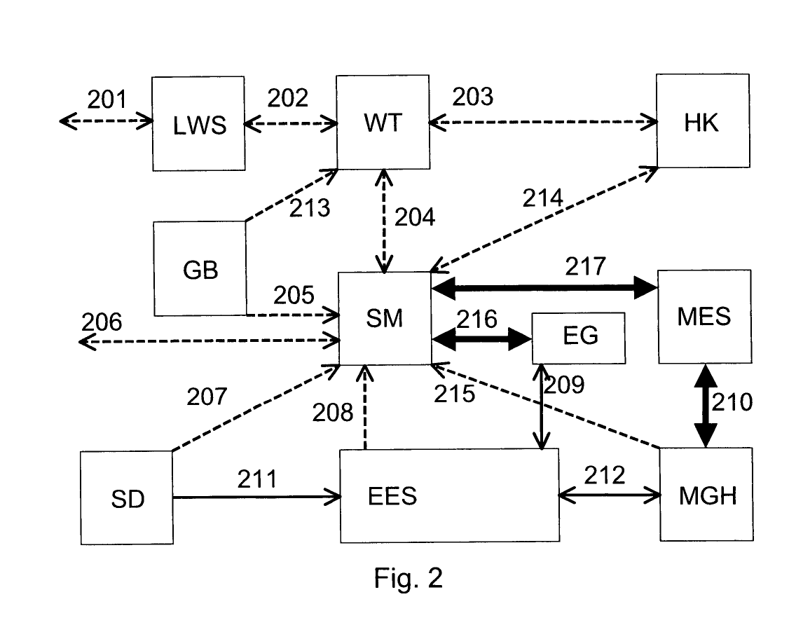

FIG. 2 a diagrammatic illustration of the assembly according to the invention by means of a preferred second example embodiment;

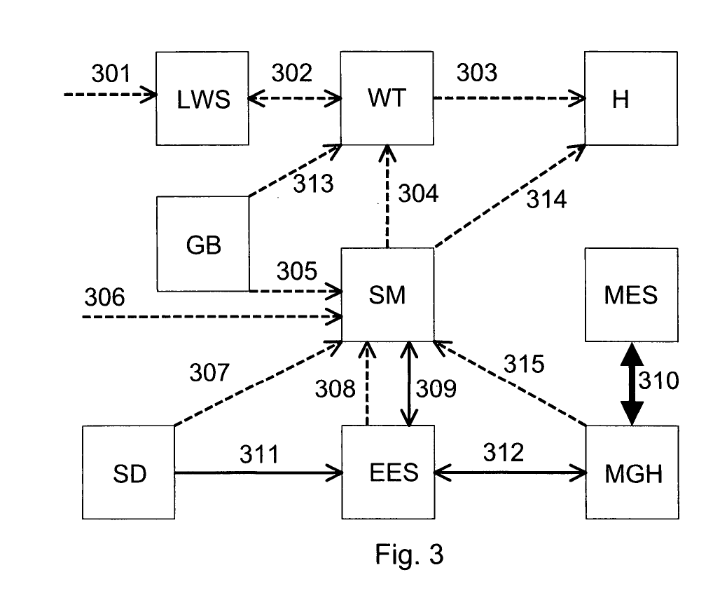

FIG. 3 a diagrammatic illustration of the assembly according to the invention by means of a preferred third example embodiment;

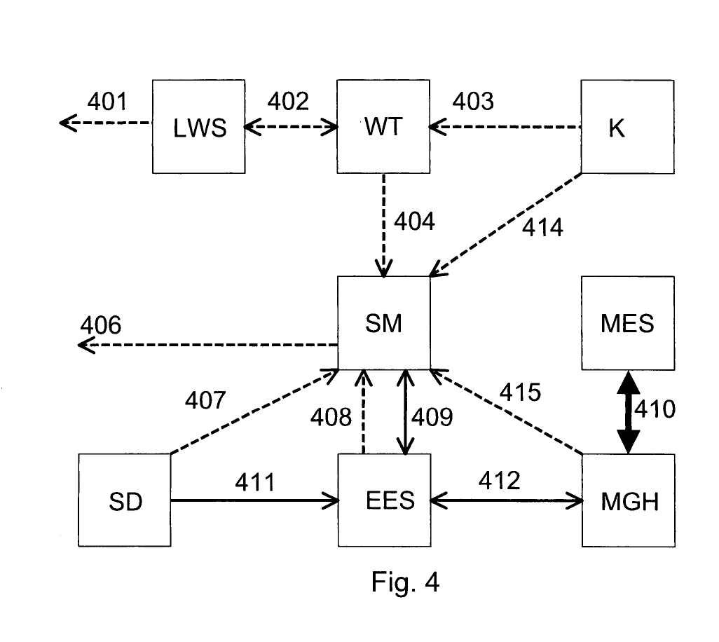

FIG. 4 a diagrammatic illustration of the assembly according to the invention by means of a preferred fourth example embodiment;

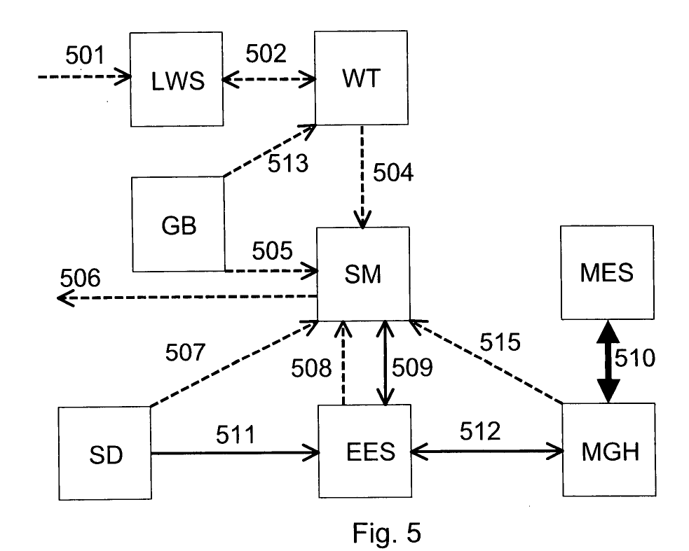

FIG. 5 a diagrammatic illustration of the assembly according to the invention by means of a preferred fifth example embodiment.

As illustrated in FIG. 1, in the assembly according to the invention for supplying energy to motorised vehicles, a heat engine SM is provided, which converts heat 106, 107, 108, 114 that accumulates in the vehicle at least partly into kinetic energy of the vehicle and feeds other portions of this heat to a heat accumulator LWS. A heat engine is a machine which converts thermal energy (also abbreviated as heat) into mechanical energy in a cyclic process. In so doing, it utilizes the attempts by the heat to flow from areas with higher temperatures to those with lower temperatures. A machine which with the use of mechanical energy transports thermal energy from a lower temperature level to a higher one is designated as a heat engine, heat pump or refrigerating machine.

Heat engines use “right-rotating” cyclic processes, in which the closed curve for instance in the T-S or p-v diagram is passed through in the sense of “top towards the right, bottom towards the left”. Heat pumps use “left-rotating” cyclic processes. An important example of a heat engine, in addition to the very widespread internal combustion engine in road vehicles, is the Stirling machine, which is designated as the Stirling engine.

The Stirling engine is a heat engine in which a closed off process gas such as air or helium is alternately heated and cooled from the exterior at two different areas, in order to generate mechanical energy. The Stirling engine operates according to the principle of a closed cyclic process and is an example of energy conversion from a poorly usable energy form (thermal energy, heat energy, microscopic kinetic energy) into the better usable energy form of mechanical energy. The Stirling engine can be operated with any desired external heat (or cold) source. There are models which already come into operation on being handled through the heat of the human hand.

Helium is used as working medium in some Stirling engines. This is pushed to and fro in a closed circuit cyclically by two pistons (working and displacing pistons) between a hot site (heater) and a cold site (cooler). The heated gas expands, the cooled gas contracts. Hereby, the pressure in the helium increases. This gas pressure acts on the crank drive via the working piston. The mechanical energy can be converted into electrical energy by electrogenerators. These electrogenerators can also operate as electric motors and in this type of operation drive the Stirling engine, which can then operate as a heat pump.

Between the heater head and the cooler, the regenerator is situated, which extracts heat from the gas on its way from the hot side to the cold side, and feeds it to it again on flowing back.

According to the example embodiment of the present invention illustrated in FIG. 1, the assembly according to the invention additionally makes provision that the vehicle is at least also driven by an electric motor NGH, and that the heat engine SM drives an electric generator EG, wherein the electrical energy 109 generated by this generator is used at least partly for the electrical drive of the vehicle.

The example embodiment of the assembly according to the invention illustrated in FIG. 1 further provides a mechanical energy accumulator LWS, which is arranged so that it can extract kinetic energy from a vehicle motor MGH, can store this energy and can emit it again, as required, to a vehicle motor MGH. Finally, the example embodiment of the assembly according to the invention illustrated in FIG. 1 also provides an electrochemical energy accumulator EES, which is arranged so that it can extract electrical energy 109, 112 from a vehicle motor MGH or from the heat engine SM, can store this energy and can emit it again, as required, to a vehicle motor MGH or to the heat engine SM.

In all the figures, arrows with dashed lines 101, 102, 103, 104, 105, 106, 107, 108, 113, 114, 115, 201, 202, 203, 204, 205, 206, 207, 208, 213, 214, 215, 301, 302, 303, 304, 305, 306, 307, 308, 313, 314, 315, 401, 402, 403, 404, 406, 407, 408, 414, 415, 501, 502, 504, 505, 506, 507, 508, 513, 515 designate an exchange of heat, whereas arrows with solid lines designate an exchange of macroscopic (“mechanical”) kinetic energy or electrical energy. Here, arrows 109, 209, 309, 409, 509, 112, 212, 312, 412, 512 with thinner solid lines designate the exchange of electrical energy, whereas arrows 110, 116, 210, 216, 217, 310, 410, 510 with thicker solid lines designate the exchange of mechanical energy. Thus, for example, the double arrow 116 in FIG. 1 designates the exchange of mechanical energy between the heat engine SM and the electric generator EG.

The electric generator EG can be coupled to the heat engine here directly, or mechanically via a gear. In a similar manner, the double arrow 110 in FIG. 1 designates a mechanical coupling of the vehicle motor MGH to the mechanical energy accumulator MES, which likewise can be embodied directly, i.e. via a shared shaft, or indirectly via a gear. The double arrows or arrows 109, 111 and 112 in FIG. 1, on the other hand, designate the transfer of electrical energy between the electrochemical energy accumulator EES and the electric generator EG or respectively the vehicle motor MGH, or respectively the transition of electrical energy 111 from a shock absorber SD to the electrochemical energy accumulator EES.

The heat exchange 102, 104 between the heat engine SM and the heat accumulator LBS preferably takes place via a heat exchanger WT, which preferably also serves to facilitate the heat transfer 103 between the heating or respectively air-conditioning system HK or the heat transfer 113 between the gas burner GB and the heat accumulator LWS. Heat can also be fed from the exterior to, or extracted 101 from the heat accumulator LWS, which is preferably designed as a latent heat accumulator. The heat engine SM can also transfer heat 105 directly from the gas burner GB or heat can be fed from the exterior 106 to the heat engine SM or can be extracted therefrom.

The shock absorbers SD can also make their waste heat 107 available to the heat engine SM, as also the electrical energy accumulator EES can make its waste heat 108 usable for the heat engine SM. Preferably also the waste heat of the vehicle motor MGH is fed to the heat engine SM. Preferably also the residual heat of the heating or respectively air-conditioning system HK is made available 114 to the heat engine SM or respectively the heat of the heat engine SM is fed to the heating or respectively air-conditioning system HK.

FIG. 2 shows a further example embodiment of the assembly according to the invention, which differs principally from the embodiment illustrated in FIG. 1 in that the mechanical energy accumulator MES is likewise coupled mechanically 217 to the heat engine SM. This embodiment of the invention is connected with the further advantage that excess kinetic energy of the heat engine SM can be fed directly to the mechanical energy accumulator MES or respectively can be extracted therefrom again as required 217, without firstly a conversion of the kinetic energy into electrical energy having to be carried out for this with the aid of the electric generator EG and a subsequent conversion into mechanical energy with the aid of the vehicle motor 209, 212, 216. Both energy conversion paths 217, 216 of this embodiment, which is illustrated in FIG. 2, have their respective advantages, however, depending on which of the two energy accumulators, the mechanical energy accumulator MES or the electrochemical energy accumulator EES is still able to receive energy or is so well filled that energy can be extracted from it as required. With the aid of the description given here, it is clear to the specialist in the art that the electric generator operates as an electric motor on extraction of energy, just as also the vehicle motor MGH as a function of the energy flow direction 210, 212 operates as a generator or as a motor.

FIGS. 3, 4 and 5 show preferred example embodiments of the invention, which are intended to clarify the energy management with the aid of the assembly according to the invention in various types of operation of the vehicle.

Thus, FIG. 3 shows the energy management in a type of operation of the invention which will frequently occur when driving in winter. Thermal energy is fed 306 to the heat engine SM, said thermal energy being extracted for example from an absorber on the vehicle roof. Likewise, the waste heat 308 of the “battery” EES is fed to the heat engine SM. Energy 203 is extracted from the heat accumulator LWS, in order to feed it 303 to the heating H.

In another type of operation of the assembly according to the invention, which is shown in FIG. 4 and which might be present principally in the summer, thermal energy 403 is extracted from a cooling apparatus of the air-conditioning system K, in order to feed it 404, 414 to the heat engine SM. As is shown in the figures, the heat transfer can preferably take place via a heat exchanger WT, but the heat exchange can also take place directly between the heat sources or respectively heat sinks and the heat engine SM. In this example embodiment according to FIG. 4, excess thermal energy 401, 406 is emitted from the heat accumulator LWS or respectively from the heat engine SM to the environment. It is clear to the specialist in the art here that the embodiments shown in FIGS. 3, 4 and 5 are able to be combined with the embodiments shown in FIG. 1 or respectively 2.

FIG. 5 shows an embodiment of the invention or respectively a type of operation of the assembly according to the invention according to a preferred embodiment of the invention and the associated energy management, in which the vehicle is driven with the aid of the heat engine SM. In this type of operation, the energy flows principally from the heat accumulator LWS to the heat engine SM. In this type of operation, heating and air-conditioning systems (cooling apparatus HK) are generally not used, because this would load the store of heat in the heat accumulator LWS too much.

Depending on the selected embodiment of the assembly according to the invention and the selected type of operation of this assembly, the lost heat—in particular the waste heats 107, 108 or 115—of various components of the assembly—in particular of the shock absorbers SD, of the electrical energy accumulator EES or of the main drive MGH, can be used very extensively and consequently is not lost. Examples of such usable quantities of heat are produced on charging and on operation of the electrochemical energy accumulator EES (battery) and on operation of the drive motor or respectively generator MGH. However, thermal energy 507 or electrical energy 511 can also be extracted from the shock absorbers SD for example during travel. For this purpose, the shock absorbers can be equipped for example with linear generators, with the aid of which the kinetic energy of the vehicle, in this case this is vibrational energy, can be converted at least partly into electrical energy and can thus be fed for a utilization 111, 211, 311, 411, 511. This type of energy conversion and utilization can be carried out alternatively or additionally to the utilization of the lost heat from the shock absorbers. For utilization of the lost heat, the shock absorbers can be equipped with a suitable cooling system.

Preferred example embodiments of the present invention further make possible a utilization of the heat which occurs through a heating of the body during solar radiation. Larger surfaces of the body—in particular the vehicle roof—are preferably embodied according to the invention as a lightweight composite structure. Ducts, which have a coolant flowing through them for example are in contact with the outer surface. In these example embodiments of the invention, the coolant transports away the heat generated by solar radiation in accordance with the principle of a solar collector 106, 206, 306, 406, 506 and feeds it to the heat engine.

Preferred example embodiments of the present invention provide for the use of a heat accumulator LWS, preferably a latent heat accumulator in the vehicle, which before the start of the journey can be heated by electrical current from the mains power supply or during the journey can be heated by the described heat loss currents 101, 201, 301, 401, 501.

A latent heat accumulator is a device which is able to store thermal energy in a “hidden” manner (latent from the Latin latere=to be hidden, therefore also the designation latent heat), with low loss, with several repeated cycles and over a long period of time. For example, so-called phase change materials are used (PCM), the latent fusion heat, solution heat or absorption heat of which is substantially greater than the specific thermal capacity of the same amount of a substance without phase conversion. Examples are heating pads, cooling packs or accumulator elements filled with paraffin in the tanks of solar thermal systems. Latent heat accumulators function by the utilization of the enthalpy of reversible thermodynamic changes of state of a storage medium, such as e.g. of the solid-liquid phase change (melting/solidifying). The utilization of the solid-liquid phase change is the most frequently used principle here. On charging of the content of commercial latent heat accumulators, mostly special salts or paraffins are melted as storage medium, which receive for this a very large amount of thermal energy, the fusion heat. As this process is reversible, the storage medium emits precisely this amount of heat again on solidification.

The heat transport 102, 202, 302, 402, 502 into the accumulator LWS can take place during travel by means of a heat engine SM, preferably a Stirling engine, which is driven by an electric motor EG. This mode of operation is preferably selected when larger amounts of heat are available than are required, or when other amounts of heat, which—for example when the vehicle is travelling downhill—from the recovery of kinetic energy of the vehicle—for example by conversion of braking energy—are available and are not required. The stored thermal energy can (without operation of the Stirling engine) be used directly for heating 103, 203, 303, 403 the vehicle, or it is partly converted into mechanical shaft work 104, 204, 304, 404, 504 in the Stirling engine. With this, the electric motor EG, now acting as generator, is driven.

The battery EES is charged as required with the generated current. The particular advantage of the Stirling engine consists in that it can be used both for the heating H and also cooling K of the vehicle or of vehicle components and in addition also for drive purposes 116, 216, 217, or for charging 109, 209, 309, 409, 509 of the battery.

Preferred example embodiments of the present invention provide for the use of a mechanical energy accumulator MES, preferably of a gearless torsional spring accumulator of lightweight construction, which is preferably connected via a coupling system directly with the drive shaft of the electric motor MGH 110, 210, 310, 410, 510.

The recovering of “braking energy” by means of the drive motor MGH, which can also act as a generator, is connected with losses in the order of 35% owing to the efficiency chain. A mechanical energy accumulator operates almost without loss. It is preferably connected via a system of couplings directly with the drive shaft. The coupling system is preferably configured so that the power input and power output can take place with the same direction of rotation. Such spring systems are suited for example to receive and emit again the kinetic energy of the vehicle with 1000 g total mass, which travels at 50 km/h. The spring accumulator with coupling system is preferably embodied as a lightweight construction. A typical total mass of such a system for the said design data is approximately 40 kg.

A preferred embodiment of the invention comprises a heat-insulated latent heat accumulator LWS with an operating temperature of approximately 500° C. with an electrically operated heating apparatus for heating 101, 201, 301, 401, 501 the accumulator before the start of the journey. Preferably, a regulated heat exchanger WT is used for heat transmission 103, 203, 303, 403 to the cooling/heating medium circuit of the vehicle.

There is preferably a central cooling/heating medium circuit HK of the vehicle, which is regulated in a suitable manner. The heat engine is preferably a Stirling engine with an operating range between approximately 5° C. (“cold head”) and 500° C. (“hot head”).

The heat engine SM, preferably a Stirling engine SM, can be used during travel or at a standstill both for the air-conditioning K and also for the heating H of the vehicle. The heads of the engine are preferably embodied as follows: The “cold head” is preferably designed as a regulated heat exchanger for heat absorption 103, 203, 403 of cooling/heating medium. The “hot head” preferably comprises two regulated heat exchangers. The first serves for heat emission 103, 203, 303 to cooling/heating medium of the vehicle at a maximum 100° C., the second serves for heat emission 102, 202, 302, 402, 502 to a suitable fluid, which heats the latent heat accumulator up to 500° C. The first and the second heat exchangers are preferably switched over by a motor-operated three-way valve.

According to some preferred embodiments of the invention, the motor/generator EG or MGH is connected via a shaft 216, 210, 217 with the heat engine SM, preferably a Stirling engine. The heat engine SM receives mechanical power when it operates as a heat pump for the heating H or air-conditioning K of the vehicle; it emits mechanical power when it operates between the temperature level of the heat accumulator WS and the ambient temperature.

According to some preferred embodiments of the invention, a gas burner GB, preferably an enclosed porous burner or another suitable burner, is operated e.g. with liquid gas, optionally as an additional heat source for the heat machine SM. The liquid gas can serve as “last reserve” in a discharged overall system. With the heat engine SM and the generator EG, electrical current can thereby be generated for charging 109, 209 the battery EES. This functionality is then a hybrid system.

According to some preferred embodiments of the invention, the shock absorbers SD are equipped with linear generators. For example, a direct current 111, 211, 311, 411, 511 is generated via a converter, which is used for charging the battery. Alternatively or in addition, the shock absorbers SD could be connected to the heating/cooling circuit HK of the vehicle, in order to utilize the lost heat directly.

According to some preferred embodiments of the invention, a mechanical energy accumulator MES, preferably a gearless torsional spring accumulator, is connected via a coupling system directly with the drive shaft of the electric motor 110, 210, 310, 410, 510.

The optimum cooperation of all or some components of the assembly according to the invention is preferably guaranteed by a suitable regulating arrangement.

Current generated from the generator EG can be converted into heat by means of an electrical resistor and can be fed for heating purposes or to a heat accumulator.

1.-8. (canceled)

9. Assembly for supplying energy to motorized vehicles,
wherein
a heat engine (SM) is provided to convert heat (106, 107, 108, 114) that accumulates in the vehicle at least partly into kinetic energy of the vehicle and to feed other portions of said heat to a heat accumulator (LWS).

10. The assembly according to claim 9, in which the vehicle is driven at least also by an electric motor (MGH), and in which the heat engine (SM) drives an electric generator (EG), wherein the electrical energy (109) generated by this generator is used at least partly for the electric drive of the vehicle.

11. The assembly according to claim 10, in which a mechanical energy accumulator (MES) is provided, which is arranged so that it can extract kinetic energy from a vehicle motor (MGH), can store this energy and can emit it again as required to a vehicle motor (MGH).

12. The assembly according to claim 11 with an electrochemical energy accumulator (EES), which is arranged so that it can extract electrical energy from a vehicle motor (MGH) or from the heat engine (SM), can store this energy and can emit it again as required to a vehicle motor (MGH) or to the heat engine (SM).

13. The assembly according to claim 12, wherein the heat engine (SM) is a Stirling engine, the cold head of which is embodied as a regulated heat exchanger for heat absorption (103, 203, 40) from a cooling or heating medium, and the hot head of which comprises two preferably regulated heat exchangers, the first of which serves for heat emission (103, 203, 303) to cooling/heating media of the vehicle, and the second of which serves for heat emission (102, 202, 302, 402, 502), which heats the latent heat accumulator up to 500° C.

14. The assembly according to claim 13, wherein the first and the second heat exchangers are switched over by a preferably motor-operated three-way valve.

15. A method for supplying energy to motorized vehicles,
wherein
a heat engine (SM) converts heat (106, 107, 108, 114) that accumulates in the vehicle at least partly into kinetic energy of the vehicle and feeds other portions of said heat to a heat accumulator (LWS).

16. The method according to claim 9, in which the vehicle is at least also driven by an electric motor (MGH), and in which the heat engine (SM) drives an electric generator (EG), wherein the electrical energy (109) generated by this generator is used at least partly for the electric drive of the vehicle.

17. The method according to claim 16, in which a mechanical energy accumulator (MES) is used to extract kinetic energy from a vehicle motor (MGH), to store this energy and to emit it again as required to a vehicle motor (MGH).

18. The method according to claim 17 with an electrochemical energy accumulator (EES), which can extract electrical energy from a vehicle motor (MGH) or from the heat engine (SM), can store this energy and can emit it again as required to a vehicle motor (MGH) or to the heat engine (SM).

19. The method according to claim 18, wherein the heat engine (SM) is a Stirling engine, the cold head of which is embodied as a preferably regulated heat exchanger for heat absorption (103, 203, 40) from a cooling or heating medium, and the hot head of which comprises two preferably regulated heat exchangers, the first of which serves for heat emission (103, 203, 303) to cooling/heating media of the vehicle, and the second of which serves for heat emission (102, 202, 302, 402, 502), which heats the latent heat accumulator up to 500° C.

20. The method according to claim 19, wherein the first and the second heat exchangers are switched over by a motor-operated three-way valve.
